(19) United States
(12) Patent Application Publication
(10) Pub. No.: US 2005/0157699 A1
(43) Pub. Date: Jul. 21, 2005

(54) Data communications device, data communications system, data communications method, data communications computer program, and computer-readable storage medium containing computer program

(75) Inventor: Koji Sakai, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/037,193

(22) Filed: Jan. 19, 2005

(30) Foreign Application Priority Data
Jan. 21, 2004 (JP) 2004-013095

(51) Int. Cl. H04L 12/28

(52) U.S. Cl. 370/351

(57) ABSTRACT

In a data communications device, if a data comparator section determines that one of two transceivers transmit/receive data, a control section returns data received from one of the transceivers with which communications are possible via that transceiver, not via the other transceiver with which communications are determined to be impossible. Therefore, even when a channel or data communications device of a data communications system experiences trouble, the whole data communications system can be prevented from being unusable.

This Nonprovisional application claims priority under 35 U.S.C. § 119(a) on Patent Application No. 2004-13095 filed in Japan on Jan. 21, 2004, the entire contents of which are hereby incorporated by reference.

### FIELD OF THE INVENTION

The present invention relates to data communications devices, data communications systems, data communications methods, data communications computer programs, and computer-readable storage media containing such computer programs, which are capable of preventing an entire data communications system from being unusable in case of trouble with a channel or data communications device in the data communications system.

### BACKGROUND OF THE INVENTION

MOST (Media Oriented Systems Transport) has been a core technology providing a means of collectively controlling navigation systems, audio, mobile phones, and various electronics in vehicles. MOST is a popular choice especially for networking multimedia devices.

MOST is a protocol for POF (plastic optical fiber)-based networks, interconnecting nodes of audio, television, navigation, and telephone systems. MOST offers various advantages to users. MOST reduces not only negative effects of the weight and noise of wire harnesses connecting various components, but also workload of system development engineers. Also, it ultimately provides the user a means of collectively controlling a variety of devices.

One of MOST's features is its capability to deliver three types of data over a network of a single, low-cost optical fiber in the following manner:

Synchronized data: real time transfer (streaming) of audio and video signals.

Non-synchronized data: packet transfer in accessing the Internet and databases.

Control data: transfer of control messages and other data for controlling the entire network.

On the MOST network, data is delivered frame by frame. Nodes are connected forming a ring. A frame is handed in one direction from one node to the next. Each frame in the MOST system is 64 bytes (512 bits). A frame contains a total of 60 bytes of areas, one for synchronized and another for non-synchronized data, The boundary between the synchronized and non-synchronized data can be altered from system to system. In the MOST network, control data is managed block by block. One block is made of 16 frames.

In MOST, a network delay detecting function is specified. In the MOST network, a 2-frame delay occurs with synchronized data delivered via a node. Detecting the delay on the network will thus reveal how many active nodes exist between a given data source and a receiving node.

An available physical topology is a ring topology which basically consists of one ring. This topology requires no hub or switch in adding a node. Another advantage is that communications lines (here, optical fibers) are not concentrated around a particular device, which eliminates unnecessary routing of fibers. The topology is also suited to, for example, the networking of electronics in vehicles in terms of installation. Further, the optical fiber network is immune to electromagnetic radiation noise and ground loop. Therefore, the ring topology is a typical topology for optical fiber networks and suitable for MOST technology. We list further advantages of the ring topology below:

The ring topology incurs no cost as to hubs or switches. The node count dictates the cost. Generally, the topology is inexpensive.

The use of a physical layer is reduced to a minimum. This lowers the cost and weight of the communications system.

Expansion is easy. A new node can be added without changing the basic architecture.

All source data (e.g., digitized audio) is available at all nodes.

An example of a MOST network in a ring topology is shown in FIG. 6. The MOST is based on an optical fiber network and connects various devices in a ring topology. As shown in FIG. 6, a controller, a car navigation system, a CD player, speakers, a CD changer, and a television set function as nodes.

This conventional node will be further explained in reference to FIG. 7 and FIG. 8. Referring first to FIG. 7, a conventional node has two transceivers. Data is acquired through one of the transceivers. If the data is for use at that particular node, a data processor section implements a predetermined process (for example, adding a flag indicating the completion of the reception). The resultant data is then transmitted from the other transceiver. Meanwhile, if the received data is not for use at the node, the acquired data is repeated and sent to an adjacent node from the other transceiver without processing the data.

Conventional nodes are assumed to be connected forming a ring topology to achieve communications as shown in FIG. 8. Data transmitted from one of the transceivers of a node is either processed at a node on the ring path or repeated over the ring back to the original node at the other transceiver, to complete the data communications. So, in the ring topology communications, the data transmitting node can detect a normal termination of a data transmission when the node receives over the ring the data which originated at that node, but has been processed by a destination node. Therefore, as shown in FIG. 9, if the node on the ring topology is not working or there is a break along a communications line, the data flow stops there. Since the data transmitting node cannot receive the data transferred back over the ring, the node cannot completes the data communications, which causes inconveniences.

To round up the discussion above, the foregoing conventional ring topology of nodes have following problems in the data communications system:

The whole data communications system goes down if the communications line, or a channel, is cut off even at a single point.

The whole system goes down if even a single node on the network breaks down and becomes unable to transmit or receive data.

The whole system goes down similarly if the optical transceiver section coupled to a node breaks.

The whole system goes down again if the optical connector coupled to the optical transceiver section of a node falls of due to an external force.

When the whole system goes down as above, the system needs to reconstructed by exchanging devices and rerouting cables.

The data communications are shown in FIG. 8 and FIG. 9 as taking place only in one direction. Data communications in the opposite direction are also possible and susceptible to the same problems.

To address the problems, Japanese published patent application 11-313098/1999 (Tokukaihei 11-313098; published on Nov. 9, 1999) discloses an optical LAN device based on a set of double branch optical couplers provided along a channel. The structure secures a minimum level of communications, preventing the entire system from going down.

However, the Tokukaihei 11-313098 optical LAN device still has a problem that a breakdown of the coupler brings down the whole data communications system. The whole data communications system goes down also if a fiber connecting a node to an adjacent one, that is, a fiber linking one double branch coupler to another, is cut off.

The foregoing description discussed problems with nodes. The same problems also occur to data communications devices when they are functioning as nodes.

### SUMMARY OF THE INVENTION

The present invention has an objective to provide a data communications device, a data communications system, a data communications method, a data communications computer program, and a storage medium containing the computer program, which are capable of preventing an entire data communications system from being unusable in case of trouble with a channel, data communications device, or other part of the data communications system.

To achieve the objective, a data communications device in accordance with the present invention has two transceivers one of which receives data and the other of which transmits data. The data communications device includes: a determiner section for determining whether data communications are possible between the two transceivers and a first data communications device and a second data communications device which perform direct data communications with the respective transceivers; and a switching section for switching whether data received from one of the transceivers is returned from that transceiver or transmitted from the other transceiver. Upon the determiner section determining that data communications are impossible between the data communications device at issue and either one of the first and second data communications devices, the switching section returns the data received from one of the transceivers connected to the other data communications device via the connected transceiver to the other data communications device.

According to the arrangement, if the determine section has determined that communications with the first data communications device are not possible (impossible), the switch section returns the data received from the second data communications device to the second data communications device via the transceiver which performs data communications with the second data communications device. On the other hand, if the determine section has determined that communications with the second data communications device are not possible (impossible), the switch section returns the data received from the first data communications device to the first data communications device via the transceiver which performs data communications with the first data communications device.

Thus, even if communications are impossible between the data communications device and either one of two data communications devices which perform direct data communications with the data communications device, the data received from the other data communications device can be returned to the other data communications device. The term “return” is used because the incoming data through one of the transceivers is output via the same transceiver.

As in the foregoing, the data communications device in accordance with the present invention can return data. Therefore, when the data communications device in accordance with the present invention is a part of a network, even if a communications line breaks, a data communications device immediately before the broken communications line can return the data. Thus, the whole system is prevented from going down due to non-transferable data. Therefore, the data communications device in accordance with the present invention can make up a data communications system which, even if a communications line breaks somewhere, does not entirely go down and allows communications between those data communications devices between which communications are possible.

In addition, when the data communications device in accordance with the present invention is a part of a network, even if, for example, a data communications device breaks, another data communications device immediately before the data communications device can return the data. In addition, a transceiver of a data communications device breaks, the data can be returned via the operational transceiver. Thus, a system can be built in which communications are possible between data communications devices between which communications are possible even if one of the data communications devices or a transceiver of a data communications device is broken.

That is, using the data communications device in accordance with the present invention, a system can be built in which communications are possible between data communications device between which communications are possible even if a disruption occurs on the system.

For example, even if a transceiver of a data communications device breaks in a ring topology network of data communications devices and thus opens up the ring topology, the remaining data communications devices can still function as a daisy chain. Thus, data communications is not interrupted. In addition, when one of two transceivers breaks, the transceiver does not need to be exchanged. The data communications device can still return the data received from the operational transceiver via the operational transceiver. Thus, when one of the transceivers fails, the data communications device can be continuously used without any modification or replacement at all. The overall cost of the system can be reduced.

In addition, even if a data communications device which is a part of the ring topology breaks, the data communications devices do not need to be reconnected. They can still function as a daisy chain for data communications, because the data communications device immediately before the broken data communications device can return the data.

In addition, even if a data communications device which is a part of the ring topology, but not in use is powered off, the other data communications devices are still connected as a daisy chain, enabling data communications. Reductions in electric consumption are expected. In addition, no data is transmitted to the transceiver to which no communicable data communications device is connected; therefore, extra workload can be reduced for members consuming electric power in the data communications device. Reductions in electric consumption are expected.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a diagram showing a data communications device in accordance with the present invention.

FIG. 2 is a drawing showing a condition of a system involving the data communications device.

FIG. 3 is a drawing showing a data flow in a system when the system is in the FIG. 2 condition.

FIG. 4 is a drawing showing a different condition of a system involving the data communications device from the FIG. 2 condition.

FIG. 5 is a drawing showing a data flow in a system when the system is in the FIG. 4 condition.

FIG. 6 is a drawing showing an example of a MOST network.

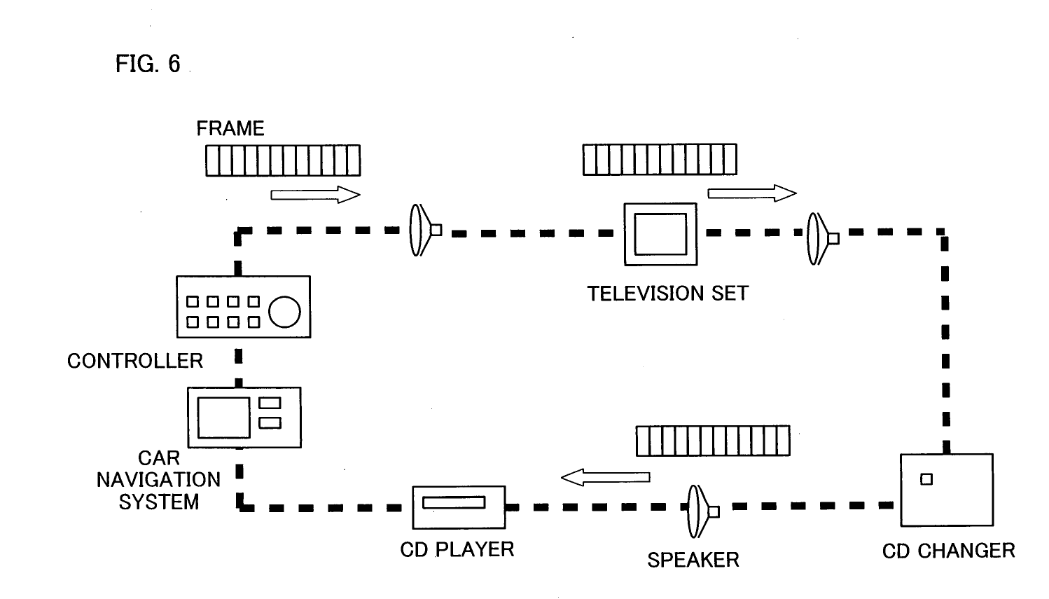

FIG. 7 is a drawing showing a data flow in a conventional data communications device.

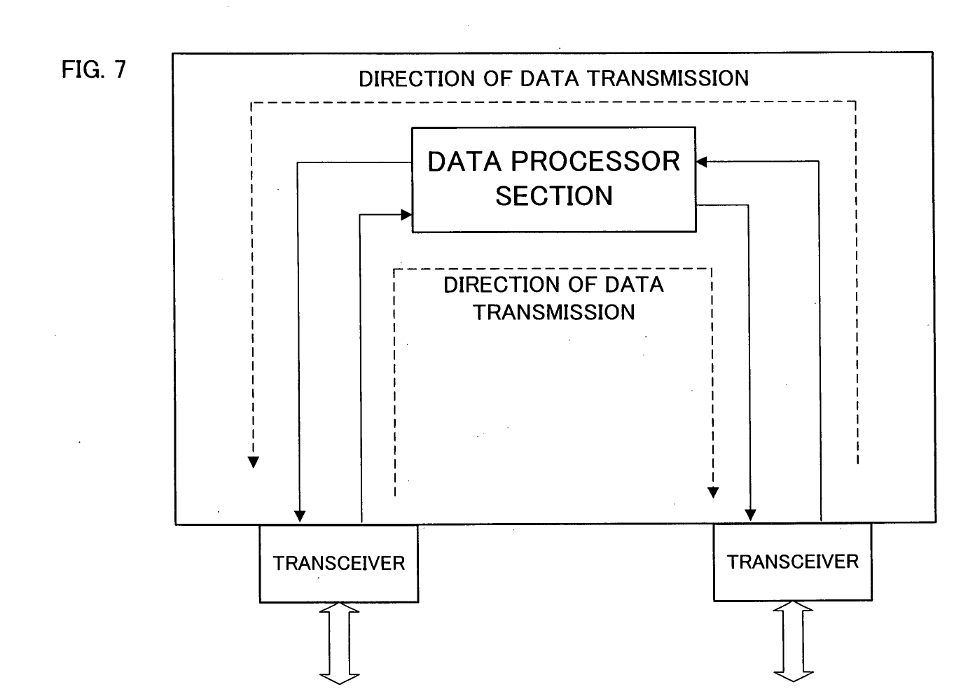

FIG. 8 is a drawing showing a data flow in a system involving conventional nodes.

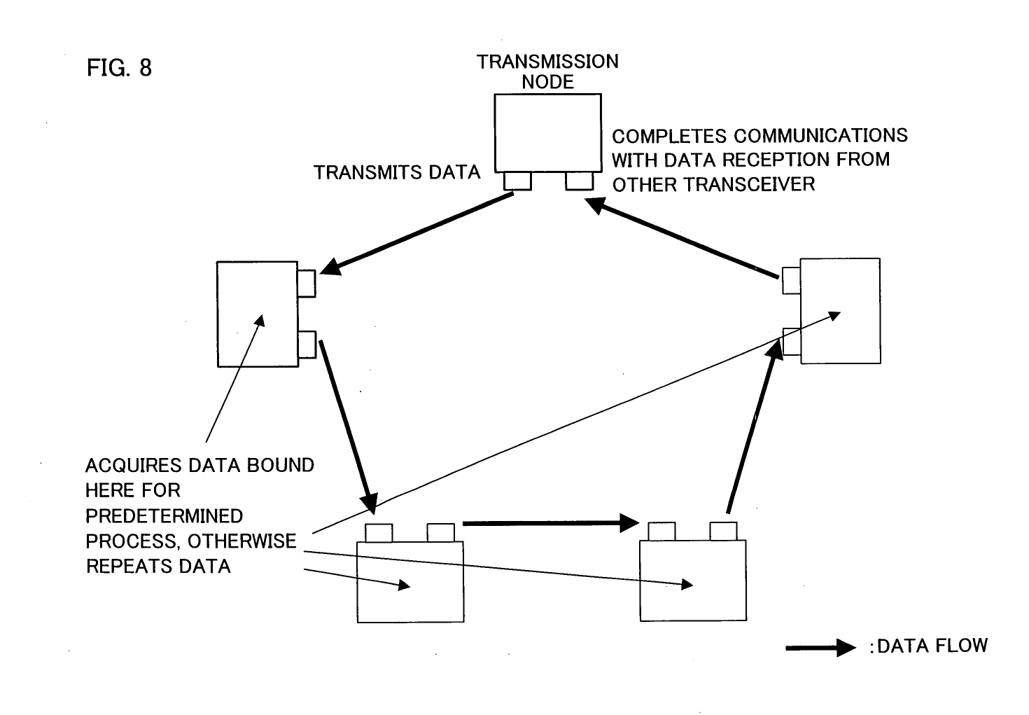

FIG. 9 is a drawing showing a system involving conventional nodes when the system cannot transfer data.

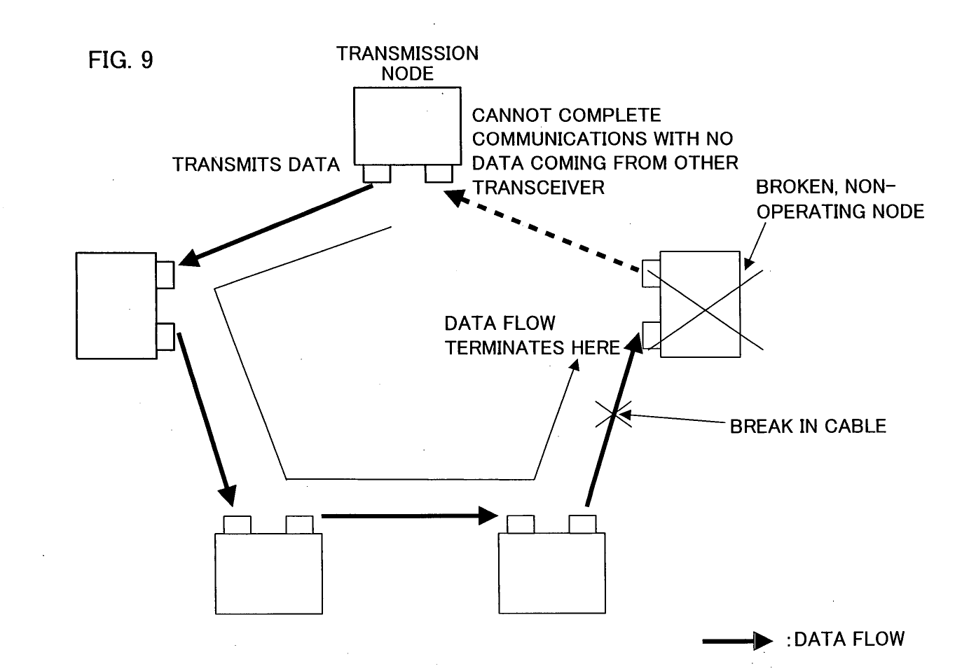

### DESCRIPTION OF THE EMBODIMENTS

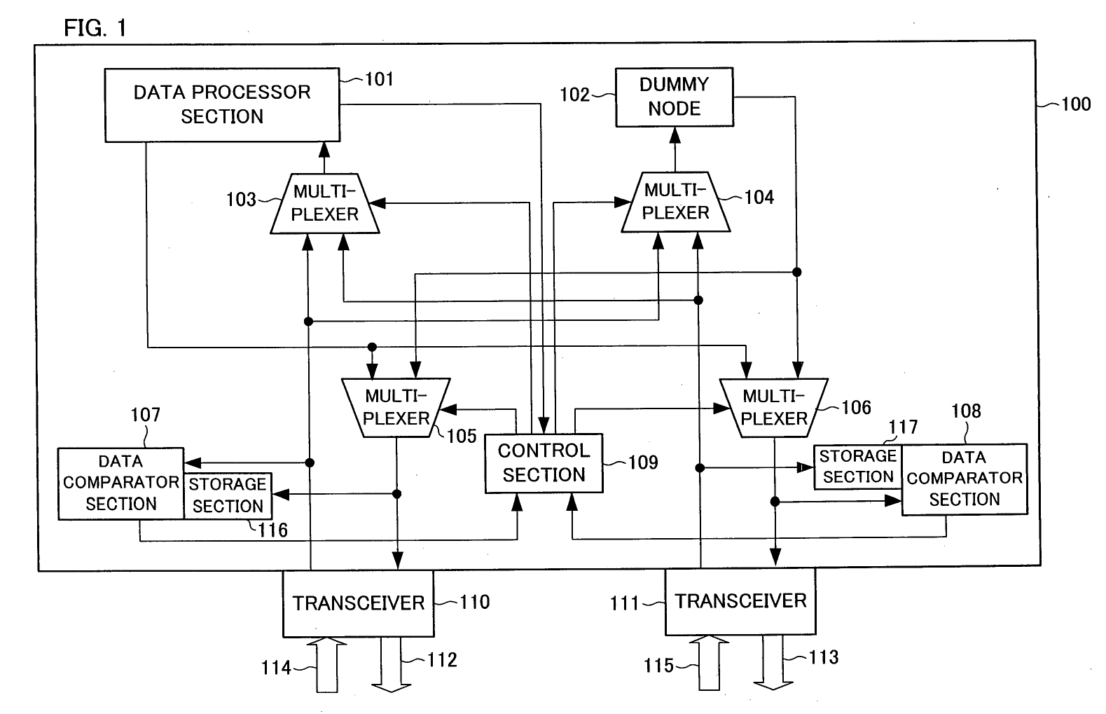

The following will describe an embodiment of the present invention in reference to FIG. 1 to FIG. 5.

The embodiment will describe the data communications devices of the present invention acting as nodes. Accordingly, the data communications device of the present embodiment will be referred to as the node 100.

The node 100 has two transceivers. Each transceiver receives data and feeds it to a control circuit in the node. If the data is for use at that particular node, the received data is subjected a predetermined process and sent out via the other transceiver. In the present embodiment, assume that the node 100 transmits and receives data by full duplex optical transmission and also that the communications lines are optical fibers. These are however mere assumptions and by no means limiting the nodes and communications lines.

### Node Construction

As shown in FIG. 1, the node 100 contains a data processor section 101, a dummy node (delay time provision means) 102, a multiplexer 103, a the multiplexer 104, a multiplexer 105, a the multiplexer 106, a data comparator section (determiner means) 107, a data comparator section (determiner means) 108, a control section (switching means) 109, a transceiver 110, a transceiver 111, a channel 112, a channel 113, a channel 114, a channel 115, a storage section 116, and a storage section 117.

Next, the members constituting the node 100 will be described in terms of their functions.

The data processor section 101 executes a predetermined process on data received from the multiplexer 103 and transmits the resultant data to the multiplexers 105, 106. Further, in response to an instruction from the control section 109, the data processor section 101 transmits required transfer data (user data) to the multiplexers 105, 106.

The dummy node 102 receives data from the multiplexer 104 and holds the data for a time as if there exists a receiving node (node where data is subjected to a process), before transmitting the resultant data to the multiplexers 105, 106. In other words, the dummy node 102 so functions that data unprocessed in the node 100 can be output at the same timing as processed data. So, the node 100 can output return data at the same timing no matter whether or not the return data is processed by the node 100. This prevents the development of an output timing discrepancy and possible interruption of communications.

In response to a control signal from the control section 109, the multiplexer 103 switchably feeds the data received from the transceiver 110 or the data received from the transceiver 111 to the data processor section 101. The multiplexer is a switching circuit selecting one output from many inputs (two inputs in the present embodiment).

In response to a control signal from the control section 109, the multiplexer 104 switchably feeds the data received from the transceiver 110 or the data received from the transceiver 111 to the dummy node 102.

In response to a control signal from the control section 109, the multiplexer 105 switchably feeds the data received from the data processor section 101 or the data received from the dummy node 102 to the transceiver 110.

In response to a control signal from the control section 109, the multiplexer 106 switchably feeds the data received from the data processor section 101 or the data received from the dummy node 102 to the transceiver 111.

The data comparator section 107 compares the data transmitted from the transceiver 110 with the data received by the transceiver 110 for a certain (predetermined) time. Based on the comparison, the data comparator section 107 determines whether communications with an adjacent node are possible and sends a signal indicative of a result of the determination to the control section 109. In the comparison, the data comparator section 107 retrieves the data transmitted from the transceiver 110 from the storage section 116.

The data comparator section 108 compares the data transmitted from the transceiver 111 with the data received by the transceiver 111 for a certain (predetermined) time. Based on the comparison, the data comparator section 108 determines whether communications with an adjacent node are possible and sends a signal indicative of a result of the determination to the control section 109. In the comparison, the data comparator section 108 retrieves the data transmitted from the transceiver 111 from the storage section 117.

The storage section 116 records data transmitted from the transceiver 110.

The storage section 117 records data transmitted from the transceiver 111.

The control section 109 sends control signals to the multiplexers 103, 104, 105, and 106 according to the signals indicative of the comparison results from the data comparator section 107 and the data comparator section 108. Upon receiving a signal from the data comparator section 107 indicating that data communications with the node adjacent to the transceiver 110 are impossible and a signal from the data comparator section 108 indicating that data communications with the node adjacent to the transceiver 111 are possible, the control section 109 has the data received from the transceiver 111 transmitted via the multiplexer 106, not via the multiplexer 105. In other words, the control section 109 switches to cause the data received from the transceiver 111 to be returned (transmitted) from the transceiver 111, instead of being transmitted from the transceiver 110. In addition, upon receiving a signal from the data comparator section 108 indicating that data communications with the node adjacent to the transceiver 111 are impossible and a signal from the data comparator section 107 indicating the data communications with the node adjacent to the transceiver 110 are possible, the control section 109 has the data received from the transceiver 110 transmitted via the multiplexer 105, not via the multiplexer 106. In other words, the control section 109 switches to cause the data received from the transceiver 110 to be returned (transmitted) from the transceiver 110, instead of being transmitted from the transceiver 111. The term “return” is used because the incoming data through one of the transceivers is output via the same transceiver.

The transceiver 110 transmits the data received from another node (node adjacent to the transceiver 110; not shown) with which the transceiver 110 performs direct data communications over the channel 114 to the multiplexer 103 and the multiplexer 104. In addition, the transceiver 110 transmits the data received from the multiplexer 105 over the channel 112 to a node adjacent to the transceiver 110.

The transceiver 111 transmits the data received from another node (node adjacent to the transceiver 111; not shown) with which the transceiver 111 performs direct data communications over the channel 115 to the multiplexer 103 and the multiplexer 104. In addition, the transceiver 111 transmits the data received from the multiplexer 106 over the channel 113 to a node adjacent to the transceiver 111.

The channel 112 and the channel 114 form a single communications line connected to the transceiver 110. Over the channel 112 is transmitted data to another node adjacent to the transceiver 110. Over the channel 114 is received data from a node adjacent to the transceiver 110.

The channel 113 and the channel 115 form a single communications line connected to the transceiver 111. Over the channel 113 is transmitted data to another data adjacent to the transceiver 111. Over the channel 115 is received data from another node adjacent to the transceiver 111.

In the present embodiment, the channel 112 and the channel 114 are assumed to form a full duplex channel on which data can be simultaneously transmitted in two directions. In addition, the channel 113 and the channel 115 are assumed to form a full duplex channel on which data can be simultaneously transmitted in two directions. A simultaneous bidirectional transmission capability increases the information transfer rate a maximum of about two fold, allowing a large size of data can be transferred quickly. The simultaneous bidirectional data transmission capability, however, is not essential.

In addition, either the channels 112, 114 or the channels 113, 115 may be constructed from a cable containing two optical fibers. An extended length of the double-fiber optical cable is fabricable and preferred for use in a data communications system especially for transmissions over long distances. In addition, the double-fiber optical cable gives a dedicated communications line for each direction, facilitating installation. This is by no means limiting the embodiment. The channels 112, 114 or the channels 113, 115 may be constructed from a cable containing a single optical fiber. A single-fiber optical cable is readily routable. In addition, the single-fiber optical cable requires a small installation area and can be readily mounted to a compact device. The channels may be not constructed from an optical fiber cable at all.

### Node Operation

Now will be described how the node 100 determines whether communications with an adjacent node are possible. It will also be described how the node 100 switchably transmits the data received from one of the transceivers via the other transceiver or returns the data via one of the transceivers. For simple description, the node performing direct data communications with the node 100 will be referred to as the first and second nodes (neither shown). Here, the node performing direct data communications with the transceiver 110 (node adjacent to the transceiver 110) will be referred to as the first node (first data communications device). The node performing direct data communications with the transceiver 111 (node adjacent to the transceiver 111) will be referred to as the second node (second data communications device). The channel 112 connects to the first node, and the channel 113 connects to the second node.

Before starting data communications, the data processor section 101 checks that no input data is coming from the transceiver 110 or the transceiver 111 by monitoring input data from the multiplexer 103. Having confirmed that no input data is coming from the transceiver 110 or the transceiver 111 for a certain time, the data processor section 101 transmits authentication data for determining whether communications are possible (connection status authentication data, or hereinafter simply “data”) from the transceiver 110 to the channel 112 via the multiplexer 105. In addition, the data processor section 101 similarly transmits authentication data from the transceiver 111 to the channel 113 via the multiplexer 106.

In the transmission of the authentication data, the authentication data transmitted from the transceiver 110 is recorded in the storage section 116, and the authentication data transmitted from the transceiver 111 is recorded in the storage section 117. The storage section 116 may be provided inside of outside the data comparator section 107. In addition, the storage section 117 may be provided inside or outside the data comparator section 108.

The data comparator section 107 compares the data transmitted from the transceiver 110 with the data received by the transceiver 110 for a certain (predetermined) time. Then, the data comparator section 107 determines whether communications with the first adjacent node are possible based on a result of the comparison (determination step) and transmits a signal indicative of a result of the determination to the control section 109. In the comparison, the data comparator section 107 retrieves the authentication data transmitted from the transceiver 110 from the storage section 116.

The data comparator section 108 similarly compares the data transmitted from the transceiver 111 with the data received by the transceiver 111 for a certain (predetermined) time. Then, the data comparator section 108 determines whether communications with the second adjacent node are possible based on a result of the comparison (determination step) and transmits a signal indicative of a result of the determination to the control section 109. In the comparison, the data comparator section 108 retrieves the authentication data transmitted from the transceiver 111 from the storage section 117.

The node 100 of the present embodiment contains the separate data comparator sections 107 and 108 which may be integrated into a single section.

Next, it will be described how the data comparator section 107 determines whether the transceiver 110 can perform data communications with the first node in three parts: (1) to (3).

(1) The data comparator section 107 receives data in less time than a minimum time taken by the transceiver 110 to receive data via the first node. Upon recognizing that the received data is identical to the authentication data transmitted from the transceiver 110 as recorded in the storage section 116, the data comparator section 107 determines that the received data is the authentication data which has traveled back. Here, “back traveling” refers to a phenomenon in a transmission in optical communications based on an optical fiber where an outgoing ray of light emitted from a light emitting section finds a path back to a light receiving section where the outgoing ray is undesirably received. This indicates that no dedicated communications lines are assigned for transmission and reception, for example, in communications over a cable containing a single optical fiber, which causes outgoing light to be received directly by the light receiving section. The term also refers to a phenomenon where an outgoing ray of light emitted from the light emitting section is reflected at a near end plane of an optical fiber where the ray enters the fiber or a far end plane of the optical fiber where the ray leaves the fiber and travels back to the light receiving section.

The back traveling of the data indicates that data communications with the first node are impossible. The data comparator section 107 determines that data communications with the first node are impossible if the transceiver 110 has received data in less time than the minimum time taken by the data reception via the first node and the received data has been recognized to be identical to the authentication data transmitted from the transceiver 110.

In addition, the minimum time taken by the data reception via the first node (hereinafter, “minimum reception time”) refers to the time taken by the data transmitted from the transceiver 110 to be returned from the first node and received by the transceiver 110. The description here discusses a transmission from the transceiver 110. So, the minimum time taken by the data to be received via the first node is designated the minimum reception time. However, in the following description, the minimum reception time refers to a time taken by data transmitted from a transceiver to be returned from another node performing direct data communications with the transceiver (node adjacent to the transceiver) and reach the transceiver (received by the transceiver).

Here, as an example, let us consider a case where the node network is MOST-compliant. Data transferred passing through an adjacent node contains a two-frame delay. That is, in this case, the minimum reception time is equal to two frames. It is therefore possible to determine whether a node is receiving a reflection of data transmitted from that node itself. That is, data which has been received before the two-frame delay and identical to the transmitted data can be determined to be the data which has been reflected back.

Whether the time taken to receive data is less than the minimum reception time can be determined by, for example, measuring time from the transmission of the authentication data from the data comparator section 107 to the reception of data.

(2) If the transceiver 110 receives no data in a certain (predetermined) time, the data comparator section 107 determines that data communications with the first node are impossible. Alternatively, the data comparator section 107 may compare the data transmitted from the transceiver 110 with void data.

Here, if the certain time is too short, the determination as to whether communications are possible becomes inaccurate. If the time is too long, the start of actual data communications following the determination as to whether communications are possible is delayed. The time is preferably specified considering these factors. For example, it is preferable if the time is a total of repeat delays equivalent to several nodes (e.g., a maximum number of connected nodes as specified by the standards). The certain time is specified longer than the minimum reception time to distinguish between the data which has traveled back and the data which returned without being processed (e.g. a case where the authentication data transmitted from the transceiver 110 has not reached the node designated as its destination, but returned to the transceiver 110 from a connected node which can return the data).

If there is no node adjacent to the transceiver 110, the data comparator section 107 determines that communications are impossible because no data is received. This is a correct determination. Thus, the data comparator section 107 can always make a correct determination even when the first node is not connected. In addition, determining that communications with the first node are possible entails determining that the first node is connected.

(3) In cases other than (1), (2) above, the data comparator section 107 determines that communications with the first node are possible.

For example, if different data than the transmitted data is received in less than the minimum reception time (for example, if data is transmitted from the first node substantially simultaneously with a data transmission from the transceiver 110, and the data from the first node is received by the transceiver 110), although data is indeed received in less time than the minimum reception time, the received data is different. The data comparator section 107 therefore determines that data communications are possible. Thus, a correct determination is made.

Let us consider another case where, for example, data is received in the minimum reception time or more.

There is a case where the authentication data transmitted from the transceiver 110 has not reached the node designated as its destination, but returned to the transceiver 110 from a connected node which is configured to be able to return the data. Here, the received data is identical to the transmitted data; however, the reception takes time more than or equal to the minimum reception time. At least it is determined that the data has been received via the first node. Therefore, the data comparator section 107 can determine that data communications with the first node are possible.

In addition, for example, there could be a case where the data transmitted from the transceiver 111 is received by the transceiver 110 after being processed. In this case, since the data is received taking the minimum reception time or even longer, the data comparator section 107 can determine that data communications with the first node are possible. For your information, if data is compared in this case, it is different data from the transmitted data that has been received.

In addition, for example, there could be a case where the authentication data transmitted from the transceiver 110 is processed at a connected node designated as its destination which is connected, and resultant data is received by the transceiver 110. In this case, the reception again takes time more than or equal to the minimum reception time. The data comparator section 107 can hence determine that data communications with the first node are possible. For your information, if data is compared in this case, it is different data from transmitted data that has been received.

In addition, for example, when data transmitted from a node other than the node 100 is received, if the reception has taken place taking longer than the minimum reception time, the data comparator section 107 determines that data communications with the first node are possible. For your information, if data is compared in this case, it is different data from the transmitted data that has been received.

From the description above, whatever data the transceiver 110 has received, if the data reception has taken place taking longer than the minimum reception time, the data comparator section 107 determines that data communications with the first node are possible. Thus, if data is received in the minimum reception time or more, the transmitted data and the received data may be compared, but may not be compared.

As in the foregoing, in any case, the data comparator section 107 can make a correct determination as to whether data communications with the first node are possible to perform direct data communications with the transceiver 110.

The data comparator section 108 also makes a similar determination to the data comparator section 107 as to whether data communications are possible between the transceiver 111 and the second node. Detailed description is therefore omitted. In any case, the data comparator section 108 can make a correct determination as to whether data communications with the second node are possible to perform direct data communications with the transceiver 111.

If the data comparator section 107 or the data comparator section 108 has received such data that they cannot make a determination, for example, the data may be sent to the data processor section 101 to make a determination in the section 101.

If the data comparator section 107 and the data comparator section 108 respectively send the results of the determinations as to whether communications are possible to the control section 109, and the results of the determinations indicate, for example, that communications with the first node are impossible whilst data communications with the second node are possible, data is transferred in the following manner. If the data received from the transceiver 111 is the data to be processed by the node 100, the data is sent via the multiplexer 103, processed by the data processor section 101, sent via the multiplexer 106, and transmitted from the transceiver 111. If not so, the data is sent via the multiplexer 104, temporarily buffered for timing adjustment by the dummy node 102 as if there existed a repeat node, sent via the multiplexer 106, and transmitted from the transceiver 111. That is, the dummy node 102 is configured to be able to output unprocessed data at the same timing as processed data.

From the description above, that is, it could be understood that the control section 109 controls the data received from the transceiver 111 so that the data travels not via the multiplexer 105, but via the multiplexer 106. In other words, the control section 109 switches to return (transmit) the data received from the transceiver 111 not from the transceiver 110, but from the transceiver 111 (switching step). The term “return” is used because the incoming data through one of the transceivers is output via the same transceiver.

In addition, if the control section 109 has received a result of a determination from the data comparator section 107 that communications with the first node are possible and a result of a determination from the data comparator section 108 that data communications with the second node are impossible, the control section 109 does the reverse to the foregoing. In other words, the data received from the transceiver 110 is switched so that data returns from the transceiver 110.

In addition, if the control section 109 has received results of determinations that communications with both the first node and the second node are possible, that is, if the node 100 and another node form a ring topology, the following takes place. Upon receiving data from the transceiver 111, if the received data is data to be processed at the node 100, the data is sent via the multiplexer 103, processed by the data processor section 101, sent via the multiplexer 105, and transmitted from the transceiver 110. If not so, the data is sent via the multiplexer 104, temporarily buffered for timing adjustment by the dummy node 102 as if there existed a repeat node, sent via the multiplexer 105, and transmitted from the transceiver 110. Conversely, when data is received from the transceiver 110, if the received data is data to be processed by the node 100, the data is sent via the multiplexer 103, processed by the data processor section 101, sent via the multiplexer 106, and transmitted from the transceiver 111. If not so, the data is sent via the multiplexer 104, temporarily buffered for timing adjustment by the dummy node 102 as if there existed a repeat node, sent via the multiplexer 106, and transmitted from the transceiver 111.

Further, the control section 109 having received a result from the data comparator section 107 may control the multiplexer 103 so that the data processor section 101 can acquire the data received by the transceiver 110. Having acquired the received data from the transceiver 110, the data processor section 101 may determine whether the received data is a result of processing of the authentication data transmitted from the transceiver 111. Alternatively, having received a result from the data comparator section 108, the control section 109 may control the multiplexer 103 so that the data processor section 101 can acquire the data received by the transceiver 111. Having acquired the received data from the transceiver 111, the data processor section 101 may determine whether the data is a result of processing of the authentication data transmitted from the transceiver 110.

In either case, if the data received from one of the transceivers is a result of processing of the data transmitted from the other transceiver, it could be understood that the current connection condition is a ring topology. The data processor section 101 is assumed to be able to determine whether the data received from one of the transceivers is a result of processing of the data transmitted from the other transceiver. In this case, the two transceivers are assumed to send different authentication data so as to distinguish between the data which has been transmitted from one of the transceivers, processed, and returned from another node and the data which has been transmitted from the other transceiver, processed, and received.

The determination as to whether the data received by one of the transceivers is the data which has been transmitted from the other transceiver and processed may be made by, for example, the data comparator section 107 or the data comparator section 108. Alternatively, another member may be provided to the node 100 to make the determination.

In this manner, if the data received from at least any one of the transceivers has been determined to be the data which was transmitted from the other transceiver and processed, data communications may be done in either of the two directions. In other words, the control section 109 may control the multiplexer 105 and the multiplexer 106 so that data communications take place only in such directions that data is received from the transceiver 110 and transmitted from the transceiver 111 or in opposite directions. Such communications in single directions reduces electric power consumption.

### Condition 1

As an example of the present embodiment, an application of the data communications device (node 100) of the present invention to the data communications system in a ring topology will be described. However, the present invention is by no means limited by the description and applicable to other data communications systems.

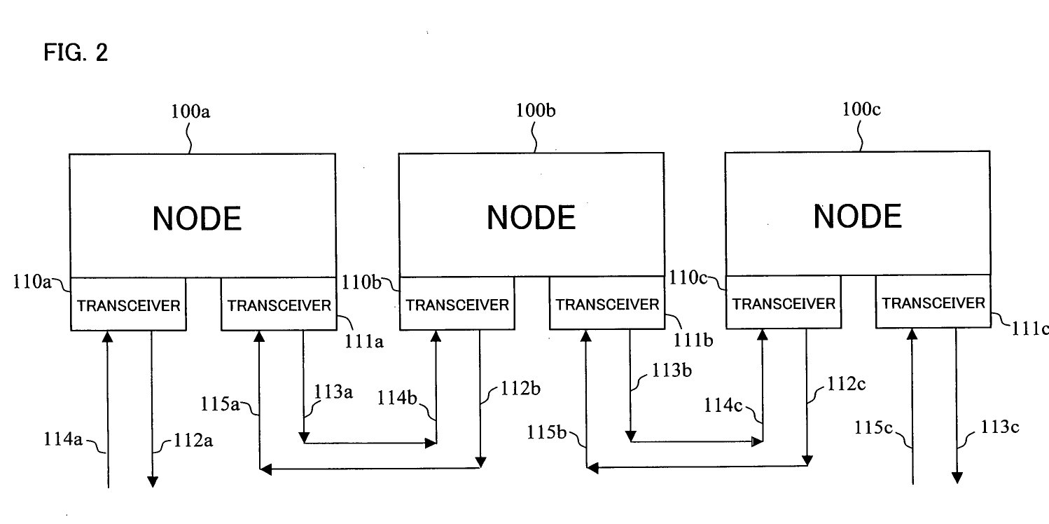

The following will describe an example of a system in which three nodes are connected in reference to FIG. 2 to FIG. 5. Each node has the aforementioned configuration and operates in the aforementioned manner. Here, the three nodes are positioned to adjacent to each other to form a data communications system. Alternatively, the system may of course involve two or four or more of such nodes.

Here, consider a conventional data communications system in which nodes are connected to form a ring. The three nodes are however now daisy chained as shown in FIG. 2 due to trouble with a channel or a node (“condition 1”). Each node has the same configuration as the node 100. The same structural members have the same functions as those in the node 100. To distinguish the nodes from one another, their reference numbers are suffixed with “a,” “b,” and “c.” That is, the three nodes are referred to as the node 100a, the node 100b, and the node 100c. In addition, for example, the control section of the node 100a which corresponds to the control section 109 of the node 100 is referred to as the control section 109a, with the same suffix attached to the reference number of the structural member as the node. These structural members correspond to the structural members of the node 100 bearing the same reference numbers.

The node 100a has two transceivers 110a, 111a to transmit and receive data by full duplex optical transmission. The transceiver 110a is a full duplex transceiver receiving data from the channel 114a and transmitting data to the channel 112a. The transceiver 111a is a full duplex transceiver receiving data from the channel 115a and transmitting data to the channel 113a.

Similarly, the node 100b has two transceivers 110b, 111b to transmit and receive data by full duplex optical transmission. The transceiver 110b is a full duplex transceiver receiving data from the channel 114b and transmitting data to the channel 112b. The transceiver 111b is a full duplex transceiver receiving data from the channel 115b and transmitting data to the channel 113b.

Similarly, the node 100c has two transceivers 110c, 111c to transmit and receive data by full duplex optical transmission. The transceiver 110c is a full duplex transceiver receiving data from the channel 114c and transmitting data to the channel 112c. The transceiver 111c is a full duplex transceiver receiving data from the channel 115c and transmitting data to the channel 113c.

Here, the channel 115a of the node 100a is connected to the channel 112b of the node 100b. Similarly, the channel 113a of the node 100a is connected to the channel 114b of the node 100b. In addition, the channel 115b of the node 100b is connected to the channel 112c of the node 100c. Similarly, the channel 113b of the node 100b is connected to the channel 114c of the node 100c. In addition, the channels 114a, 112a of the node 100a and the channels 115a, 113c of the node 100c are all open. That is, the node 100a is connected to the node 100b, the node 100b is connected to the node 100c, and the node 100a is not connected to the node 100c.

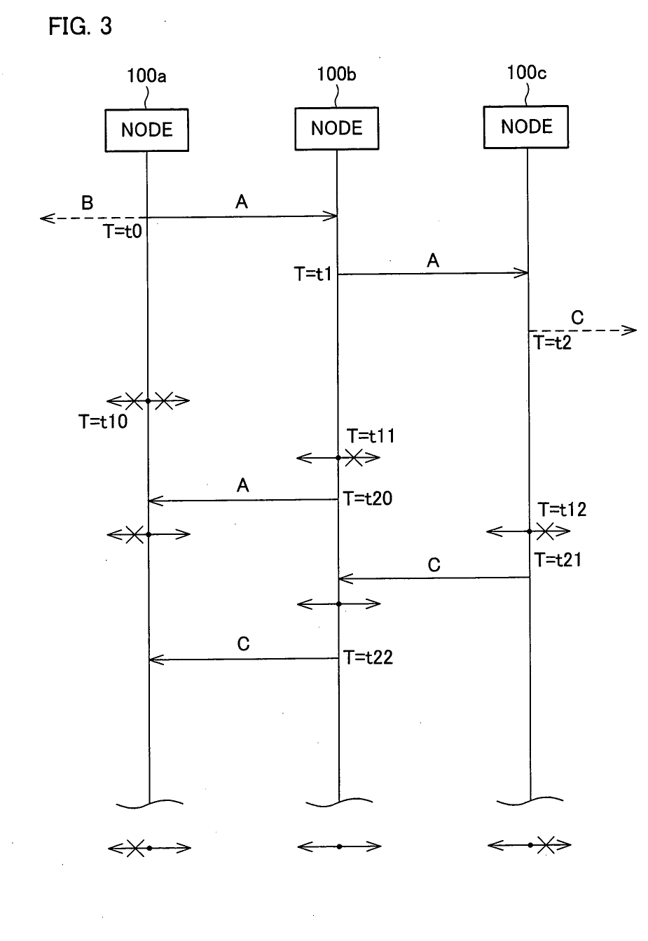

Next, the operation of the nodes and an authentication data flow will be described in reference to FIG. 3. Arrows in FIG. 3 indicate data flow.

In this example, the node 100a is assumed to be a transmission node transmitting authentication data and have initiated a data transmission. However, this is by no means limiting the present invention. Another node may initiate a data transmission.

Initially, after checking that no data has been input from the transceiver 110a and the transceiver 111a for a certain time, the data processor section 101a of the node 100a transmits data B, or authentication data, from the transceiver 110a via the channel 112a time T=t0 and similarly transmits data A, or authentication data, from the transceiver 111a via the channel 113a. Upon the transmission, the data B transmitted from the transceiver 110a is recorded in the storage section 116a, and the data A transmitted from the transceiver 111a is recorded in the storage section 117a. Here, the data A, B is assumed to be bound for the node 100c, in other words, be processed by the node 100c.

The data A transmitted from the transceiver 111a at time T=t0 is received by the transceiver 110b. Meanwhile, the data B transmitted from the transceiver 110a at time T=t0 is not received by any other node, because communications are not possible between the transceiver 110a and any other node.

The data A transmitted from the transceiver 111a at time T=t0 and received by the transceiver 110b is given a delay time (because its destination is the node 100c and it is not processed by the node 100b) transmitted from the transceiver 111b at time T=t1. Upon the transmission, the data A transmitted from the transceiver 111b is recorded in the storage section 117b. The data A transmitted from the transceiver 111b at time T=t1 is received by the transceiver 110c of the node 100c. The data A received by the transceiver 110c is processed by the data processor section 101c to produce post-processing data C. The data C transmitted from the transceiver 111c at time T=t2. Upon the transmission, the data C transmitted from the transceiver 111c is recorded in the storage section 117c.

As shown in FIG. 3, let time=t10 be the time when a certain preset time elapses after the transmission of the data A, or authentication data, from the transceiver 111a. In addition, let time T=t11 be the time when a certain preset time elapses after the transmission of the data A from the transceiver 111b. In addition, let time T=t12 be the time when a certain preset time elapses after the transmission of the data C from the transceiver 111c.

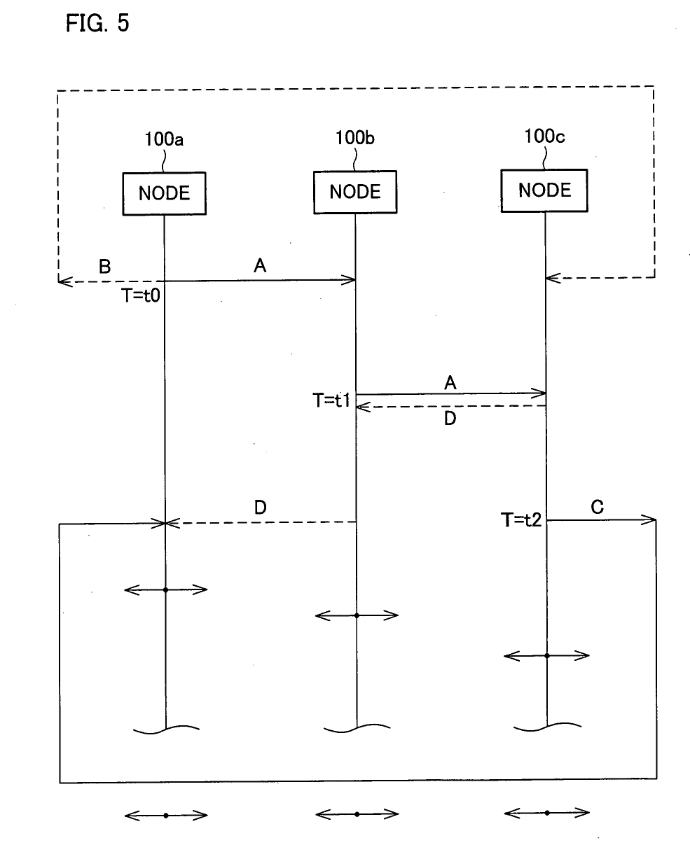

Since the transceiver 111a receives no data for a certain preset time, the data comparator section 108a of the node 100a determines at time T=t10 that communications with the node 100b adjacent to the transceiver 111a are impossible and sends the result to the control section 109a. Simultaneously, since the transceiver 110a receives no data for a certain preset time, the data comparator section 107a determines that communications with the node adjacent to the node 110a are impossible and sends the result to the control section 109a. Here, it is now understood that communications are impossible between the node 100a and its adjacent node. In FIG. 3, a pair of short, joined arrows indicates a data communications condition determined by a node. In other words, data cannot be transmitted in a direction indicated by an arrow marked with a “x.” Data can be transmitted in a direction indicated by an arrow with no “x” mark. The same display method applies to FIG. 5.

Next, since the transceiver 111b receives no data for a certain preset time, the data comparator section 108b of the node 100b determines at time T=t1 that communications are impossible between the transceiver 111b and its adjacent node 100c, and sends the result to the control section 109b. Since data was received by the transceiver 110a at time T=t0, the data comparator section 107b determines that communications are possible between the transceiver 110b and its adjacent node 100a, and sends the result to the control section 109b. At time T=t20, the control section 109b controls the multiplexer 105b to return the data A received from the transceiver 110b from the transceiver 110b. Here, the node 100b is only known to be communicable with the node 100a.

The data A returned from the transceiver 110b at time T=t20 is received by the transceiver 111a of the node 100a. It is identical to the data A recorded in the storage section 117a, but the reception took place the certain time or even more after the data transmission at T=t0. A time more than the minimum reception time elapsed (as mentioned earlier, the certain time is always set longer than the minimum reception time). The data comparator section 108a therefore determines that communications are possible between the transceiver 111a and its adjacent node 100b, and sends to the control section 109a. Here, since no data is again received from the transceiver 110a, it is now understood that communications are possible between the node 100a and the node 100b. Accordingly, the control section 109a causes the data received from the transceiver 111a to be returned from the transceiver 111a.

Next, since the transceiver 111c receives no data for a certain preset time, the data comparator section 108c of the node 100c determines at time T=t12 that communications are impossible between the transceiver 111c and its adjacent node, and sends the result to the control section 109c. Since data was received by the transceiver 110c at time T=t1, the data comparator section 107c determines that communications are possible between the transceiver 110c and its adjacent node 100b, and sends the result to the control section 109c. Therefore, at time T=t21, the control section 109c controls the multiplexer 105c to process the data A received from the transceiver 110c and returns the resultant data as data C from the transceiver 110c.

The data C returned from the transceiver 110c at time T=t21 is received by the transceiver 111b of the node 100b. The data is different from the data A recorded in the storage section 117b and the reception took place the certain time or even more after the data transmission at T=t1. A time more than the minimum reception time has elapsed. The data comparator section 108b therefore determines that communications are possible between the transceiver 111b and its adjacent node 100c, and sends to the he control section 109b. Since data communications with the node 100a have been already determined to be possible, the control section 109a control the multiplexer 105b and gives the data C received from the transceiver 111b a delay time before transmitting the data C at T=t22 from the transceiver 110b. Here, it could be understood that data communications are possible between the node 100b and the nodes 100a, 100c.

The data C transmitted from the transceiver 110b at time T=t22 is received by the transceiver 111a. The reception of the post-processing data C for the data A transmitted from the node 100a is assumed to end the authentication data communications.

Note that at any node, if the transceiver 110 receives data in less time than the minimum reception time, and the data is identical to the authentication data retrieved from the storage section 116, the data comparator section 107 determines that the transceiver 110 cannot connect to its adjacent node. In addition, at any node, if the transceiver 111 receives data in less time than the minimum reception time, and the data is identical to the authentication data retrieved from the storage section 117, the data comparator section 108 determines that the transceiver 111 cannot connect to its adjacent node. Since the minimum reception time is specified less than the certain time, even when the transceivers 110, 111 receive data which has traveled back, a correct determine can be made.

As in the foregoing, when the authentication data communications ends (time T=t22), it is confirmed that the node 100a is connected to the node 10b, the node 100b to the nodes 100a, 100c, and the node 100c to the node 100b. the control section 109a causes the data received by the transceiver 111a to be returned from the transceiver 111a. The control section 109c causes the data received by the transceiver 110c to be returned from the transceiver 110c. In addition, the control section 109b cause the data received by the transceiver 110b to be transmitted from the transceiver 111b and that the data received by the transceiver 111b is transmitted from the transceiver 110b. It could be understood that these actions data communications are possible between nodes between communications are possible.

Once the connection status of the nodes is determined by means of the authentication data, data communications are performed as in ordinary data communications.

In addition, if the node 100b is a transmission node, communications between the nodes 100a, 100c are determined to be impossible after the certain time. Thereafter, when data is returned from the transceiver 111a of the node 100a and the transceiver 110c of the node 100c, communications between the nodes 100a, 100c are determined to be possible. At the node 100a, if data is received by the transceiver 111a from the node 100b and no data is received at all from the node 110a even after the certain time, communications with the node 100b are determined to be possible. At the node 100c, if data is received by the transceiver 110c from the node 100b and no data is received at all from the transceiver 111c even after the certain time, communications with the node 100b are determined to be possible.

Thus, even if identification data is transmitted from the node 100b, the connections of the nodes are correctly determined.

In addition, when identification data from the node 100c is transmitted, similarly to the node 100a, the connections of the nodes are correctly determined.

That is, the connections of the nodes are correctly determined from no matter which node identification data is transmitted (no matter which node is the transmission node). Then, data communications are performed between nodes between which communications are possible.

In addition, even if two nodes are daisy chained or even if more than three nodes are daisy chained, the connections of the nodes are correctly determined. For example, two non-adjacent nodes are broken in a system of multiple nodes connected in a ring topology can be viewed as two daisy chain node systems. In these cases, the connections of the nodes are again correctly determined, allowing communications between working nodes.

Condition 2

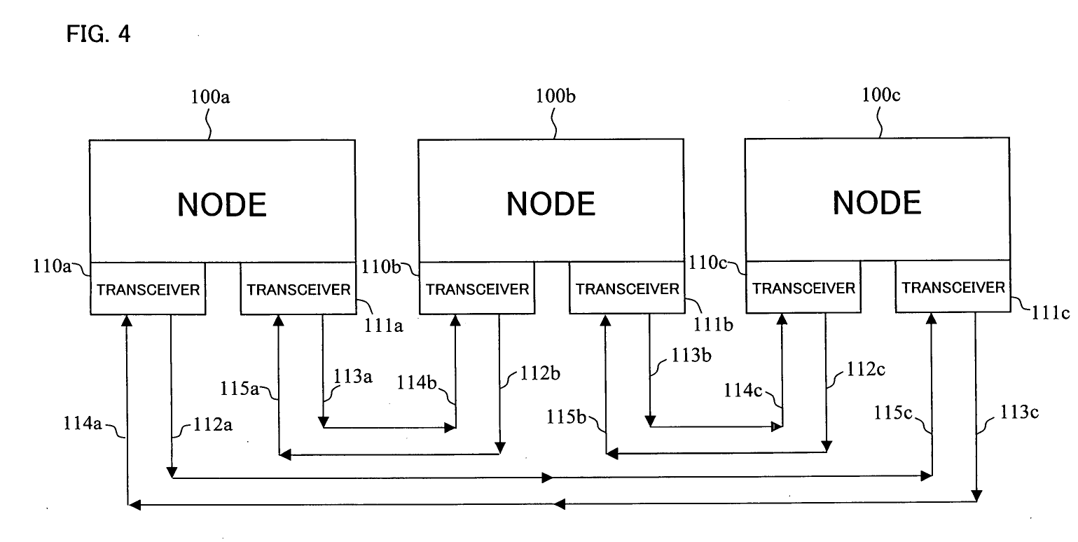

The following will describe an example of a system, in a different condition from condition 1, in which three nodes 100 of the present embodiment are connected in reference to FIGS. 4, 5.

Here, the three nodes are assumed to be connected to form a ring as shown in FIG. 4 with no trouble with the channels or nodes (“condition 2”).

Each node has the same configuration as the node 100. The same structural members have the same functions as those in the node 100. That is, all the three nodes are similar to condition 1, with the only difference being the connection status. Thus, the nodes are referred to as the node 100a, the node 100b, and the node 100c. In addition, the structural members of each node are again similar to condition 1.

As described in relation to condition 1, the node 100a, node 10b, and node 100c each have two transceivers to transmit and receive data by full duplex optical transmission. In addition, all the transceivers are full duplex transceivers.

The node 100a has two transceivers 110a, 111a to transmit and receive data by full duplex optical transmission. The transceiver 110a is a full duplex transceiver receiving data from the channel 114a and transmitting data to the channel 112a. The transceiver 111a is a full duplex transceiver receiving data from the channel 115a and transmitting data to the channel 113a.

The node 100b has two transceivers 110b, 111b to transmit and receive data by full duplex optical transmission. The transceiver 110b is a full duplex transceiver receiving data from the channel 114b and transmitting data to the channel 112b. The transceiver 111b is a full duplex transceiver receiving data from the channel 115b and transmitting data to the channel 113b.

The node 100c has two transceivers 110c, 111c to transmit and receive data by full duplex optical transmission. The transceiver 110c is a full duplex transceiver receiving data from the channel 114c and transmitting data to the channel 112c. The transceiver 111c is a full duplex transceiver receiving data from the channel 115c and transmitting data to the channel 113c.

Here, the channel 114a of the node 100a is connected to the channel 113c of the node 100c. Similarly, the channel 112a of the node 100a is connected to the channel 115c of the node 100c. In addition, the channel 115a of the node 100a is connected to the channel 112b of the node 100b. Similarly, the channel 113a of the node 100a is connected to the channel 114b of the node 100b. In addition, the channel 115b of the node 100b is connected to the channel 112c of the node 100c. Similarly, the channel 113b of the node 100b is connected to the channel 114c of the node 100c.

In condition 1, the channels 114a, 112a of the node 100a and the channels 115a, 113c of the node 100c were all open. In condition 2, differences lie where the channel 114a of the node 100a is connected to the channel 113c of the node 100c, and similarly, the channel 112a of the node 100a is connected to the channel 115c of the node 100c. That is, in condition 1, the node 100a was connected to the node 10b, the node 100b was connected to the node 100c, and the node 100a was not connected to the node 100c. In condition 2, the node 100a is connected to the node 100b, the node 100b is connected to the node 100c, and the node 100c is connected to the node 100a.

Next, the operation of the nodes will be described in reference to FIG. 5.

In this example, the node 100a is assumed to be a transmission node transmitting authentication data and have initiated a data transmission. However, this is by no means limiting the present invention. Another node may initiate a data transmission.

An authentication data flow will be first described. After checking that no data has been input from the transceiver 110a and the transceiver 111a for a certain time, the data processor section 101a of the node 100a transmits data B, or authentication data, from the transceiver 110a via the channel 112a at time T=t0 and similarly transmits data A, or authentication data, from the transceiver 111a via the channel 113a. Upon the transmission, the data B transmitted from the transceiver 110a is recorded in the storage section 116a, and the data A transmitted from the transceiver 111a is recorded in the storage section 117a. Here, the data A, B is assumed to be bound for the node 100c, in other words, be processed by the node 100c.

The data A transmitted from the transceiver 111a at time T=t0 is received by the transceiver 110b. Meanwhile, the data B transmitted from the transceiver 110a at time T=t0 is received by the transceiver 111c.

The data A transmitted from the transceiver 111a at time T=t0 and received by the transceiver 110b is given a delay time from the dummy node 102b, because its destination is not that node. The data A is then transmitted from the transceiver 111b at time T=t1. Upon the transmission, the data A transmitted from the transceiver 111b is recorded in the storage section 117b. Meanwhile, the data B transmitted from the transceiver 110a at time T=t0 and received by the transceiver 111c is processed by the data processor section 101c to produce post-processing data D. The data D is transmitted from the transceiver 110c at time T=t1. Upon the transmission, the data D transmitted from the transceiver 110c is recorded in the storage section 116c.

The data A transmitted from the transceiver 111b at time T=t1 is received by the transceiver 110c of the node 100c. The data A received by the transceiver 110c is processed by the data processor section 101c to produced post-processing data C. The data C is transmitted from the transceiver 111c at time T=t2. Upon the transmission, the data C transmitted from the transceiver 111c recorded in the storage section 117c. Meanwhile, the data D transmitted from the transceiver 110c at time T=t1 received by the transceiver 111b. The data D received by the transceiver 111b is given a delay time from the dummy node 102b and transmitted from the transceiver 110b, because its destination is not that node. Upon the transmission, the data D transmitted from the transceiver 110b is recorded in the storage section 116b.

The data C transmitted from the transceiver 111c at time T=t2 is received by the transceiver 110a of the node 100a. In addition, the data D transmitted from the transceiver 110b at time T=t2 is received by the transceiver 111a of the node 100a.

Next, an operation will be described whereby it is determined whether communications are possible between each node and the other nodes.

At the node 100a, the transceiver 110a receives data at time T=t2. The data comparator section 107a retrieves data B from the storage section 116a and compares it with the data C received from the transceiver 110a. Since the comparison has shown that the data is different, it is determined that communications with the adjacent node 100c are possible, and the result is sent to the control section 109a. In addition, the data comparator section 108a retrieves the data A from the storage section 117a and compares it with the data D received from the transceiver 111a. Since the comparison has shown that the data is different, it is determined that communications with the adjacent node 100b are possible, and the result is sent to the control section 109a. Here, it could be understood that data communications are possible between the node 100a and the nodes 100b, 100c.

Here, when the transceiver 110a has received data, the data comparator section 107a determines whether communications with an adjacent node are possible. When the transceiver 111a has received data, the data comparator section 108a determines whether communications with an adjacent node are possible. However, whether data communications with an adjacent node are possible may be determined after the certain time. In other words, supposing that the certain preset time elapses after a transmission of the data A and the data B at time T=t10, the data comparator section 107a and the data comparator section 108a may make the determination at or after T=t10. That is, from the fact that the transceiver 110a has received data with the certain time (Here, time T=t2), the data comparator section 107a determines that data communications are possible. In addition, from the fact that the transceiver 111a receives data with the certain time (Here, time T=t2), the data comparator section 108a determines that data communications are possible. In the foregoing description, the data comparator section 107 and the data comparator section 108 of other nodes, upon data reception, also determined whether communications are possible. The section 107, 108 may make such a determination after the certain time similarly to the node 110a.

At the node 100b, since the transceiver 110b has received data at time T=t0, the data comparator section 107b determines that communications are possible between the transceiver 110b and its adjacent node 100a, and sends the result to the control section 109b. Substantially simultaneously with the transmission of the data A at time T=t1, the transceiver 111b receives the data D. That is, after a data transmission, the reception takes place in less time than a maximum reception time. However, the data comparator section 108b knows that the received data D differs from the data A retrieved from the storage section 117b, thus determines data communications with the adjacent node 100c are possible, and sends the result to the control section 109b. Here, it could be understood that data communications are possible between the node 100b and the nodes 100a, 100c.

At the node 100c, since the transceiver 110c has received data at time T=t1, the data comparator section 107c determines that communications are possible between the transceiver 110c and its adjacent node 100b, and sends the result to the control section 109c. Further, since the transceiver 111c has received the data B at time T=t0, the data comparator section 107c determines that communications are possible between the transceiver 111c and its adjacent node 100a, and sends the result to the control section 109c. Here, it could be understood that data communications are possible between the node 100c and the nodes 100b, 100a.

Note that at any node, if the transceiver 110 receives data in less time than the minimum reception time, and the data is identical to the authentication data retrieved from the storage section 116, the data comparator section 107 determines that the transceiver 110 cannot connect to its adjacent node. In addition, at any node, if the transceiver 111 receives data in less time than the minimum reception time, and the data is identical to the authentication data retrieved from the storage section 117, the data comparator section 108 determines that the transceiver 111 cannot connect to its adjacent node. Since the minimum reception time is specified less than the certain time, even when the transceivers 110, 111 receive data which has traveled back, a correct determination can be made.

The reception of the post-processing data C for the data A transmitted from the transmission node 100a at time T=t2 is assumed to end the data A communications. In addition, the reception of the post-processing data D for the data B transmitted from the transmission node 100a at time T=t2 is assumed to end the data B communications.

As in the foregoing, when the communications for the data A, B, or authentication data, end, it is confirmed that the node 100a is connected to the nodes 100b, 100c, the node 100b is connected to the nodes 100a, 100c, and the node 100c is connected to the nodes 100b, 100a. In FIG. 5, a pair of short, joined arrows indicates a data communications condition determined by a node. In other words, the arrows indicate that the nodes 1, 2, 3 can handle bidirectional data communications. The control section 109a causes the data received by the transceiver 110a to be transmitted from the transceiver 111a and the data received by the transceiver 111a to be transmitted from the transceiver 110a. The control section 109b causes the data received by the transceiver 110b to be transmitted from the transceiver 111b and the data received by the transceiver 111b to be transmitted from the transceiver 110b. In addition, the control section 109c causes the data received by the transceiver 110c to be transmitted from the transceiver 111c and the data received by the transceiver 111c to be transmitted from the transceiver 110c.

Once the connection status of the nodes is determined by means of the authentication data as in the foregoing, data communications are performed as in ordinary data communications.

Incidentally, upon the end of the authentication data communications, at the node 100a, the control section 109a having received the result from the data comparator section 107a may control the multiplexer 103a and causes the data processor section 101a to acquire the data C received by the transceiver 110a. Upon the acquiring of the data C from the transceiver 110, the data processor section 101a may determine whether the received data is a result of processing of the data A transmitted from the transceiver 111a. Alternatively, the control section 109a having received the result from the data comparator section 108a may control the multiplexer 103a and causes the data processor section 101a to acquire the data D received by the transceiver 111a. Upon the acquiring of the data D from the transceiver 111a, the data processor section 101a may determine whether the data is a result of processing of the data B transmitted from the transceiver 110a.

In either case, if the data received from one of the transceivers has been determined to be a result of processing of the data transmitted from the other transceiver, it could be understood that the current connection condition is a ring topology. In the foregoing, the determination was made based on a result from the data comparator section 107a or the data comparator section 108a; the determination may be made based on results from the both data comparator sections.

In this manner, if the data received from at least any one of the transceivers has been determined to be the data which was transmitted from the other transceiver and processed, data communications may be done in either of the two directions. In other words, the control section 109 may control the multiplexer 105 and the multiplexer 106 so that data communications take place only in such directions that data is received from the transceiver 110 and transmitted from the transceiver 111 at any node. Conversely, the control section 109 may control the multiplexer 105 and the multiplexer 106 so that data communications take place only in such directions that data is received from the transceiver 111 and transmitted from the transceiver 110. Such communications in single directions reduces electric power consumption.

In addition, even if the nodes 100b, 100c are transmission nodes, the connections of the nodes are correctly determined similarly to the node 100a.

That is, even if identification data is transmitted from any node, the connections of the nodes are correctly determined.

As in the foregoing, even when a node cannot communicate with one of the two nodes with which the node is performing direct data communications, the use of node 100 of the present embodiment can return the data received from the other node through this node.

Therefore, if the node 100 of the present embodiment is part of a network, when, for example, a communications line is broken somewhere, the node immediately before the broken communications line can return the data. This prevents the whole system from going down due to a failure in data transfer. Thus, with the node 100 of the present embodiment, the system can be configured so that communications are possible between nodes between which communications are possible and that even when a communications line is broken somewhere, the whole data communications system does not go down.

In addition, if the node 100 of the present embodiment is part of a network, when, for example, a node breaks, the node immediately before the broken node can return the data. In addition, a transceiver of a node breaks, the other, operational transceiver can return the data. Thus, the system can be configured so that even when a node or its transceiver fails, communications are still possible between nodes between which communications are possible.

That is, the node 100 of the present embodiment allows the system to be configured so that communications are possible between nodes between which communications are possible even if a part of the system fails to function.

For example, even if a transceiver of a node breaks in a ring topology network of nodes and thus opens up the ring topology, the remaining nodes can still function as a daisy chain. Thus, data communications is not interrupted. In addition, when one of two transceivers of a node breaks, the transceiver does not need to be replaced. The node can still return the data received from the operational transceiver via the operational transceiver. Thus, when one of the transceivers fails, the node can be continuously used without any modification or replacement at all. The overall cost of the system can be reduced.

In addition, even if a node which is a part of the ring topology breaks, the nodes do not need to be reconnected. They can still function as a daisy chain for data communications, because the node immediately before the broken node can return the data.

In addition, even if a node which is a part of the ring topology, but not in use is powered off, the other nodes are still connected as a daisy chain, enabling communications. Reductions in electric consumption are expected. As a result, no data is transmitted to the transceiver to which no communicable node is connected; therefore, extra workload can be reduced for members consuming electric power in the node. Reductions in electric consumption are expected.

Incidentally, the members of the nodes and the processing steps of the embodiment can be realized by a CPU or other computing means executing a computer program contained in a ROM (Read Only Memory), RAM, or other storage means to control a keyboard or like input means, a display or like output means, or an interface circuit or like communications means. Therefore, the various functions and processes of the node of the present embodiment can be realized if a computer equipped with these means simply reads a storage medium containing the program and executing the program. In addition, if the program is contained in a removable storage medium, the various functions and processes can be realized on any given computer.

Such a computer program storage medium may be a memory (not shown), such as a ROM, so that the process is executable on a microcomputer. Alternatively, a program medium may be used which can be read by inserting the storage medium in an external storage device (program reader device; not shown).

In addition, in either of the cases, it is preferable if the contained program is accessible to a microprocessor which will execute the program. Further, it is preferable if the program is read, and the program is then downloaded to a program storage area of a microcomputer where the program is executed. Assume that the program for download is stored in a main body device in advance.

In addition, the program medium is a storage medium arranged so that it can be separated from the main body. Examples of such a program medium include a tape, such as a magnetic tape and a cassette tape; a magnetic disk, such as a flexible disk and a hard disk; a disc, such as a CD/MO/MD/DVD; a card, such as an IC card (inclusive of a memory card); and a semiconductor memory, such as a mask ROM, an EPROM (erasable programmable read only memory), an EEPROM (electrically erasable programmable read only memory), or a flash ROM. All these storage media hold a program in a fixed manner.

In addition, the node 100 may be configured so that it can connect to a communications network. This allows the program code to be provided over the communications network. Examples of such a communications network is not limited in any particular manner and may be the Internet, intranet, extranet, LAN, ISDN, VAN, CATV communications network, virtual private network, telephone line network, mobile communications network, and satellite communications network. In addition, the transmission medium providing the communications network is not limited in any particular manner and may be those complying with the IEEE 1394 or USB standards, an electric power line, cable TV line, telephone line, ADSL line, or another wired medium. Wireless alternatives include an IrDA or like infrared-based remote control system, Bluetooth (registered trademark), 802.11 wireless, HDR, mobile phone network, satellite line, and terrestrial digital network. Incidentally, the present invention may be realized in the form of computer data signals which is an embodiment of the program code embodied by an electronic transmission and embedded in a carrier wave.

Incidentally, to download the program over the communications network, it is preferred if the program for download is stored in a main body device in advance or installed from another storage medium.

As in the foregoing, a data communications device in accordance with the present invention has two transceivers one of which receives data and the other of which transmits data. The data communications device includes: determiner means for determining whether data communications are possible between the two transceivers and a first data communications device and a second data communications device which perform direct data communications with the respective transceivers; and switching means for switching whether data received from one of the transceivers is returned from that transceiver or transmitted from the other transceiver. Upon the determiner means determining that data communications are impossible between the data communications devices at issue and either one of the first and second data communications devices, the switching means returns the data received from one of the transceivers connected to the other data communications device via the connected transceiver to the other data communications device.

The data communications device in accordance with the present invention, incorporating all the foregoing features, further includes a storage section for recording transmitted data. With respect to the two transceivers, if data is received in less time than a minimum time taken for the data to be received via one of the first and second data communications devices which perform direct data communications with the transceivers, and also if the data received from the transceiver is identical to data transmitted from the transceiver stored in the storage section or if the transceiver receives no data at all for a predetermined time, the determiner means may determine that data communications are impossible between that transceiver which has received no data and one of the first and second data communications device which performs direct data communications with that transceiver.

Here, the minimum time taken by the data reception via one of the first and second data communications devices which performs direct data communications with the transceiver (hereinafter, “minimum reception time”) refers to the time taken by the data transmitted from the transceiver to be returned by another transceiver performing direct data communications with that transceiver and reach the transceiver. Thus, if data is received in less time than the minimum reception time, and the data is identical to the transmitted data, it indicates that the data did not reach the data communications device performing direct data communications with the transceiver, in other words, traveled back.

Data being returned without reaching the data communications device performing direct data communications with the transceiver indicates that data communications are impossible with the data communications device.

For example, the mere fact that data is received in less time than the minimum reception time may indicate that data was transmitted from the first data communications device substantially simultaneously with the data transmission from the transceiver, and the data was received by the transceiver. Therefore, it cannot be correctly determined whether data communications are possible with the data communications device performing direct data communications with the transceiver. In addition, the mere fact that the received data is identical to the transmitted data may indicate that data did not reach the data communications device designated as the destination and returned by a data communications device which was connected and can return the data. Therefore, it cannot be correctly determined whether data communications are possible with the data communications device performing direct data communications with the transceiver. In contrast, as in the foregoing, with the arrangement of the present invention, it is determined whether data is received in less time than the minimum reception time and the data is identical to the transmitted data. Therefore, no matter what data is received, the data communications device in accordance with the present invention can correctly determine whether data communications are possible with the data communications device performing direct data communications with the transceiver.

In addition, if the transceiver receives no data at all for a predetermined time, the determiner means determines that data communications are impossible. Here, if the predetermined time is too short, the determination as to whether communications are possible becomes inaccurate. If the time is too long, the start of data communications following the determination as to data whether communications are possible is delayed. The time is preferably specified considering these factors. Incidentally, to distinguish between the data which has traveled back and the data which returned without being processed, the predetermined time needs to be specified longer than the minimum reception time.

It may be said that in cases other than those mentioned above, the determiner means determines that data communications are possible. For example, if data was transmitted from the first data communications device substantially simultaneously with a data transmission from the transceiver, and the data is received by the transceiver, the determiner means determines that data communications are possible, because the received data is different although the data is received in less time than the minimum reception time. Thus, a correct determination can be made.

That is, according to the arrangement, it can be determined in any case whether data communications are possible or impossible.

Incidentally, determining whether data communications with the first and second data communications devices performing direct data communications are possible entails determining whether the first and second data communications devices are connected. That is, if no data communications device performing direct data communications is connected, since no data is received, the determiner means determines that communications are impossible, which is a correct determination. Thus, the determiner means can always correct determine even if no data communications device performing direct data communications is connected. Incidentally, data communications being possible entails that the data communications device performing direct data communications being connected.

Data communications with the data communications device for direct communications are impossible when a data communications device performing direct data communications with the data communications device at issue is not operational; when a communications line between the data communications device at issue and the data communications device performing direct data communications is not operational; when a transceiver of the data communications device at issue is not operational; and when there exists no data communications device for direct communications.

As in the foregoing, in any case, a correct determination can be always made.

The data communications device in accordance with the present invention, incorporating all the foregoing features, may produce a delay time so that when the data received from one of the transceivers connected to either one of the first and second data communications devices is returned from that transceiver from which the data is received, if the received data is not data to be processed by the data communications device at issue, the received data can be output at an identical timing as if the received data was processed. The data is thereafter returned.

According to the arrangement, the return data can be output at the same timing no matter whether the data received is processed or not by the data communications device at issue. This prevents the development of an output timing discrepancy and possible interruption of communications.

The data communications device in accordance with the present invention, incorporating all the foregoing features, may perform data communications with the first and second data communications devices by full duplex optical communications.

Here, full duplex is bidirectional communications in which data can be transmitted and received simultaneously in both directions.

According to the arrangement, bidirectional communications can be carried out simultaneously, allowing a maximum of about a two-fold increase in information transfer rate. A large size of data can thus be transferred at high speed.

The data communications device in accordance with the present invention, incorporating all the foregoing features, may perform data communications with the first and second data communications devices over a cable containing a single optical fiber.

According to the arrangement, the cable containing a single optical fiber can be installed easily. In addition, the cable requires a small installation area and can be readily mounted to a compact device.

The data communications device in accordance with the present invention, incorporating all the foregoing features, may perform data communications with the first and second data communications devices over a cable containing two optical fibers.

According to the arrangement, the cable, or communications line, can be fabricated in extended length and preferred for use in a data communications system especially for transmissions over long distances. In addition, the cable gives a dedicated data communications line for each direction, facilitating installation.

The data communications device in accordance with the present invention, incorporating all the foregoing features, and when data transmitted from at least either one of the transceivers and processed is received by the other one of the transceivers, may perform data communications in only one direction such that data is transmitted from one of the transceiver device and data is received from the other transceiver device and not perform data communications in the opposite direction such that data is transmitted from the other transceiver device and data is received from one of the transceiver device.

According to the arrangement, even if bidirectional communications are possible, data communications is performed in only in one direction. Therefore, no electric power is needed for data communications in the opposite direction (for example, standby electric power). Reductions in power consumption are expected.

The data communications device in accordance with the present invention, incorporating all the foregoing features, may be used for a multimedia device.

Here, a multimedia device refers to a device where computer information processing technology is incorporated into an information medium and bidirectional information exchange is performed. Thus, according to the arrangement, the data communications device of the present invention is applicable to on-board electronics, such as car navigation, car audio, and mobile phone systems. These are by no means limiting the multimedia device. Other examples include home electronic appliances. In this manner, the data communications device in accordance with the present invention is applicable to home electronic appliances, etc.

Another data communications system in accordance with the present invention, to solve the problems, is a data communications system including a network of a plurality of the data communications devices.

According to the arrangement, each data communications device in the system, even if communications become impossible between the data communications device at issue and either one of the two data communications devices which perform direct data communications with the data communications device at issue, returns the data received from the other one of the data communications devices to the data communications device.

Therefore, according to the arrangement, for example, if a broken communications line occurs in the system, the data communications device immediately before the broken communications line returns the data. This prevents the whole system from going down due to a failure in data transfer. Communications become possible between data communications devices between which communications are possible.

In addition, according to the arrangement, for example, if a data communications device breaks down, the data communications device immediately before that broken data communications device returns data. In addition, if a transceiver of the data communications device at issue breaks down, the data can be returned via the operational transceiver. Therefore, even when the data communications device or its transceiver is broken, communications are possible between data communications devices between which communications are possible.

That is, in the data communications device system in accordance with the present invention, communications are possible between data communications devices between which communications are possible even if a disruption occurs on the system.

To solve the problems, a data communications method in accordance with the present invention is a data communications method for a data communications device having two transceivers one of which receives data and the other of which transmits data. The method is characterized by involving the determination step of determiner means determining whether data communications are possible between the two transceivers and a first data communications device and a second data communications device which perform direct data communications with the respective transceivers; and the switching step of the switching means switching whether data received from one of the transceivers is returned from that transceiver or transmitted from the other transceiver. Further, upon the determiner means determining in the determination step that data communications are impossible between the data communications device at issue and either one of the first data communications device and the second data communications device, the switching means in the switching step returns the data received from one of the transceivers connected to the other data communications device via the transceiver to the other data communications device.

According to the method, even if communications become impossible between the data communications device at issue and either one of the two data communications devices which perform direct data communications with the data communications device at issue; the data received from the other data communications device can be returned to the other data communications device.

Therefore, in a network of data communications devices, for example, even if a communications line breaks, the data communications device immediately before the broken communications line can return the data. This prevents the whole system from going down due to a failure in data transfer. Thus, the data communications method in accordance with the present invention enables communications between data communications devices between which communications are possible without letting the whole data communications system going down even if the communications line breaks down somewhere.

In addition, in a network of data communications devices, even if a data communications device breaks down, the data communications device immediately before the broken data communications device can return the data. In addition, if a transceiver of the data communications device at issue breaks down, the data can be returned via the operational transceiver. Therefore, according to the data communications method in accordance with the present invention, even when the data communications device or its transceiver is broken, communications are possible between data communications devices between which communications are possible.

That is, according to the data communications method in accordance with the present invention, even if a disruption occurs on the system, communications are possible between data communications devices between which communications are possible.

Incidentally, the data communications device may be realized by a computer, in which case, a data communications computer program realizing the data communications device by a computer by causing the computer to operate as the means and a computer-readable storage medium containing such a data communications computer program also falls within the scope of the present invention.

The present invention detailed so far can prevent the whole data communications system from being unusable even if a disruption occurs on the data communications system. Therefore, the invention is preferably applicable to a data communications device and data communications system. It is also preferably applicable to multimedia devices, such as on-board electronics and intelligent home appliances.

The embodiments and examples described in Best Mode for Carrying Out the Invention are for illustrative purposes only and by no means limit the scope of the present invention. Variations are not to be regarded as a departure from the spirit and scope of the invention, and all such modifications as would be obvious to one skilled in the art are intended to be included within the scope of the claims below.

1. A data communications device with two transceivers one of which receives data and the other of which transmits data, said data communications device comprising:
determiner means for determining whether data communications are possible between the two transceivers and a first data communications device and a second data communications device which perform direct data communications with the respective transceivers; and
switching means for switching whether data received from one of the transceivers is returned from that transceiver or transmitted from the other transceiver,
wherein upon the determiner means determining that data communications are impossible between said data communications device and either one of the first and second data communications devices, the switching means returns the data received from one of the transceivers connected to the other data communications device via the connected transceiver to the other data communications device.

2. The data communications device as set forth in claim 1, wherein when the data received from one of the transceivers connected to either one of the first and second data communications devices is returned from the transceiver from which the data is received, a communications line used to receive the data is used.

3. The data communications device as set forth in claim 1, wherein the transceivers are connected to the first and second data communications devices respectively via a single communications line.

4. The data communications device as set forth in claim 1, further comprising a storage section for recording transmitted data,
wherein with respect to the two transceivers, if data is received in less time than a minimum time taken for the data to be received via one of the first and second data communications devices which perform direct data communications with the transceivers, and also if the data received from the transceiver is identical to data transmitted from the transceiver stored in the storage section or if the transceiver receives no data at all for a predetermined time, the determiner means determines that data communications are impossible between that transceiver which has received no data and one of the first and second data communications devices which performs direct data communications with that transceiver.

5. The data communications device as set forth in claim 1, further comprising delay time provision means for producing a delay time so that when the data received from one of the transceivers connected to either one of the first and second data communications devices is returned from that transceiver, if the received data is not data to be processed by said data communications device, the received data can be output at an identical timing as if the received data was processed.

6. The data communications device as set forth in claim 1, wherein connection status authentication data is transmitted in advance to determine whether data communications are possible between the two transceivers and the first and second data communications devices which perform direct data communications with the respective transceivers.

7. The data communications device as set forth in claim 1, wherein said data communications device performs data communications with the first and second data communications devices by full duplex optical communications.

8. The data communications device as set forth in claim 7, wherein said data communications device performs data communications with the first and second data communications devices over a cable containing a single optical fiber.

9. The data communications device as set forth in claim 7, wherein said data communications device performs data communications with the first and second data communications devices over a cable containing two optical fibers.

10. The data communications device as set forth in claim 1, wherein when data transmitted from at least either one of the transceivers and processed is received by the other one of the transceivers, said data communications device performs data communications in only one direction such that data from one of the transceivers is transmitted and data from the other one of the transceivers is received, said data communications device performing no data communications in an opposite direction.

11. The data communications device as set forth in claim 1, wherein said data communications device is used for a multimedia device.

12. A data communications system, comprising a network of a plurality of the data communications device of claim 1.

13. The data communications system as set forth in claim 12, wherein the network has a ring topology.

14. A data communications method for a data communications device with two transceivers one of which receives data and the other of which transmits data, said method comprising:
the determination step of determining whether data communications are possible between the two transceivers and a first data communications device and a second data communications device which perform direct data communications with the respective transceivers; and
the switching step of switching whether data received from one of the transceivers is returned from that transceiver or transmitted from the other transceiver,
wherein upon determining in the determination step that data communications are impossible between said data communications device and either one of the first and second data communications devices, the switching step returns the data received from one of the transceivers connected to the other data communications device via the connected transceiver to the other data communications device.

15. A data communications computer program causing the data communications device of claim 1 to operate, said program causing the computer to realize the means.

16. A computer-readable storage medium containing the data communications computer program of claim 15.
